(19) United States
(12) Patent Application Publication
(10) Pub. No.: US 2007/0077322 A1
(43) Pub. Date: Apr. 5, 2007

(54) Resin molding apparatus

(75) Inventors: Kanji Sekihara, Toyokawa-shi (JP); Shinichiro Hara, Kobe-shi (JP)

Correspondence Address: BRINKS HOFER GILSON & LIONE, P.O. BOX 10395, CHICAGO, IL, 60610, US

(73) Assignee: KONICA MINOLTA OPTO, INC.

(21) Appl. No.: 11/540,994

(22) Filed: Sep. 28, 2006

(30) Foreign Application Priority Data
Sep. 30, 2005 (JP) JP2005-285905

(51) Int. Cl. B29C 45/64; B28B 17/00

(52) U.S. Cl. 425/168; 425/589

(57) ABSTRACT

A resin molding apparatus wherein a movable platen for supporting a movable mold is connected to a fixed platen for supporting a fixed mold by tie bars. The movable platen has bush bearings, and the movable platen is movable along the tie bars via the bush bearings. A low friction surface treatment is applied to at least either the outer circumferences of the tie bars or the inner circumferences of the bush bearings.

This application is based on Japanese patent application No. 2005-285905, the content of which is incorporated herewith by reference.

### BACKGROUND OF THE INVENTION

1. Field of the Invention

The present invention relates to a resin molding apparatus and more particularly to a resin molding apparatus which is suited for molding of small optical elements such as lenses.

2. Description of Related Art

In a resin molding apparatus, generally, a movable mold is moved to come into contact with and separate from a fixed mold (for clamping and opening). Specifically, the movable mold is supported by a movable platen, and the movable platen slides on a tie bar which is fixed to a fixed platen. In this case, it is required to have good slidability between the tie bar and a bush bearing provided for the movable platen.

Conventionally, as Japanese Patent Laid-Open Publication No. 2001-246627 discloses, a lubricant (grease) is filled between the tie bar and the bush bearing. However, the use of a lubricating oil requires periodical oil supplies, and the oil supplies may cause an axial gap between the fixed mold and the movable. Even when an automatic oil supplying method is adopted, it is likely that each automatic oil supply causes a change in the axial gap between the fixed mold and the movable mold. The axial gap prevents smooth opening/closing of the molds, causes uneven distribution of clamping force on a separating surface and causes deformation of molding spaces. Especially in molding very small optical elements such as microlenses, the axial gap between the fixed mold and the movable mold may result in an axial gap between surfaces of each of the molded microlenses. Therefore, it is very difficult to obtain molded products with stable optical performance.

Japanese Utility Model Laid-Open Publication No. 7-11322 discloses that the bush bearing of the movable platen has a porous ceramic layer impregnated with a lubricant. This is to implement the idea of automatic oil supplies. However, problems such as durability, etc. are left unsolved.

### SUMMARY OF THE INVENTION

An object of the present invention is to provide a resin molding apparatus which performs smooth opening/closing of molds without using a lubricant and which produces molded products of high quality.

In order to attain the object, a resin molding apparatus according to the present invention comprises a movable platen for supporting a movable mold, a fixed platen for supporting a fixed mold, a tie bar for connecting the movable platen to the fixed platen and a bush bearing fixed to the movable platen at a position to be in contact with the tie bar such that the movable platen is movable along the tie bar via the bush bearing. In the apparatus, a low friction surface treatment is applied to at least one of a surface of the tie bar in contact with the bush bearing and a surface of the bush bearing in contact with the tie bar.

The tie bar may pierce through the bush bearing, and in this case, the low friction surface treatment may be applied to an outer circumference of the tie bar or an inner surface of the bush bearing.

The low friction surface treatment is preferably forming a hard lubricating layer made of diamond-like carbon, forming a hard lubricating layer made of diamond-like carbon containing an additive or forming a hard lubricating layer made of CrN.

In the resin molding apparatus according to the present invention, a low friction surface treatment is applied to at least either the outer circumference of the tie bar or the inner circumference of the bush bearing provided for the movable platen. Therefore, the opening/closing motions of the molds are smooth, and occurrences of axial gaps due to oil supplies can be avoided. Also, the posture of the movable platen during an opening/closing motion is stable, and the clamping force is distributed evenly. Therefore, deformation of the separating surface can be minimized. Thereby, the accuracy of the molded products is improved, and it is possible to mold especially very small optical elements without any problems such as an axial gap between surfaces, etc. When the resin molding apparatus is of a type which molds a plural number of products at a time, that is, when the apparatus has a plural number of molding spaces, variations among the plural number of molding spaces in deformation can be minimized. Accordingly, there is no fear that the molded products may vary in performance. Further, since no lubricants are used, the clearance between the tie bar and the bush bearing can be filled to the utmost, which is very effective to prevent an axial gap between the movable mold and the fixed mold.

### BRIEF DESCRIPTION OF THE DRAWINGS

This and other objects and features of the present invention will be apparent from the following description with reference to the accompanying drawings in which:

FIG. 1 is an elevational view of a part of a resin molding apparatus according to an embodiment of the present invention; and

FIG. 2 is a sectional view of a mold showing an essential part of the internal structure.

### DETAILED DESCRIPTION OF THE PREFERRED EMBODIMENTS

Embodiments of a resin molding apparatus according to the present invention will be described with reference to the accompanying drawings.

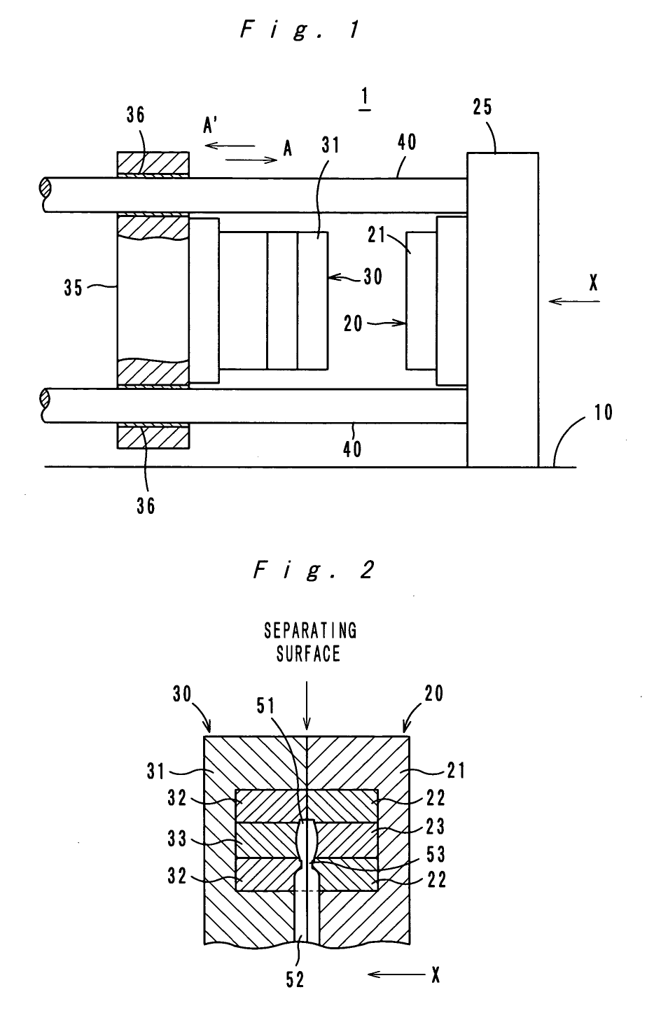

FIG. 1 shows a resin molding apparatus 1 according to an embodiment of the present invention. This resin molding apparatus 1 has, on a base 10, a fixed platen 25 for supporting a fixed mold 20. A movable platen 35 for supporting a movable mold 30 is fitted to tie bars 40 such that the movable platen 35 is movable horizontally (in directions A and A′) via the tie bars 40. The tie bars 40 are located to pierce through the respective four corners of the platens 25 and 35.

The movable platen 35 is driven to move horizontally by a driving mechanism (not shown). When the movable platen 35 is moving in the direction A, the molds 20 and 30 are clamped, and when the movable platen 35 is moving in the direction A′, the molds 20 and 30 are opened. In the first embodiment, the clamping force is designed within a range from 5 tons to 15 tons.

FIG. 2 shows the internal structures of the molds 20 and 30. The fixed mold 20 has a base 21, a cavity 22 and a core 23, and likewise, the movable mold 30 has a base 31, a cavity 32 and a core 33. The molds 20 and 30 are so structured as to mold, for example, eight small optical elements (resin lenses) at one injection cycle, that is, eight molding spaces 51 are formed between the molds 20 and 30. Here, a member having a surface with an optical surface of a resin lens transferred thereto is called “core”, and a member having a surface with a flange of the resin lens transferred thereto is called “cavity”.

A runner 52 is connected to each of the molding spaces 51 via a gate 53. An injection unit (not shown) extends from the direction X to the rear side of the fixed mold 20 via the inside of a locating ring 61 (which will be described later), and melted resin ejected from the injection unit is injected into the molding spaces 51 via the respective runners 52 and gates 53.

Each of the tie bars 40 is fixed to the fixed platen 25 at one end and fixed to a rear platen (not shown) at the other end. The movable platen 35 is fitted to the tie bars 40 via bush bearings 36 such that the movable platen 35 slides on the tie bars 40 via the bush bearings 36. A low friction surface treatment is applied to at least either the outer circumferences of the tie bars 40 or the inner circumferences of the bush bearings 36. It is not necessary to apply the low friction surface treatment to the tie bars 40 entirely, and it is necessary to apply the low friction surface treatment to merely the parts where the bush bearings 36 slide.

It is sufficient if the low friction surface treatment is as effective as a lubricant conventionally used for an improvement in the slidability. The low friction surface treatment is, for example, forming a hard lubricating layer made of DLC (diamond-like carbon), forming a hard lubricating layer made of DLC containing an additive or forming a hard lubricating layer made of CrN. These hard lubricating layers are effective enough to improve the slidability and the durability. Although it is preferred that such hard lubricating layers are formed on both the outer circumferences of the tie bars 40 and the inner circumferences of the bush bearings 36 by the low friction surface treatment, it is sufficient to form hard lubricating layers either the outer circumferences of the tie bars 40 or the inner circumferences of the bush bearings 36.

According to this embodiment, at least either the outer circumferences of the tie bars 40 or the inner circumferences of the bush bearings 36 provided for the movable platen 35 are subjected to the low friction surface treatment, and smooth opening/closing of the molds 20 and 30 is possible without using a lubricant. Therefore, an axial gap due to an oil supply can be avoided. Also, the posture of the movable platen 35 during an opening/closing motion is stable, and an even distribution of clamping force can be achieved even during a continuous molding operation. Therefore, deformation of the separating surface between the molds 20 and 30 can be minimized. Thereby, the quality of molded products can be improved, and very small optical elements without any problems such as an axial gap between surfaces, etc. can be obtained.

Also, variations among the molding spaces 51 in deformation can be minimized, and accordingly, variations among the molded products in performance can be minimized. Further, since a lubricant is not used, the clearances of the tie bars 40 and the clearances of the bush bearings 36 can be filled to the utmost, which is very effective for prevention of an axial gap.

### Other Embodiments

The detailed structures of the fixed platen and the movable platen and the structures of the platens may be designed arbitrarily.

Although the present invention has been described in connection with the preferred embodiment, it is to be noted that various changes and modifications are possible to those who are skilled in the art. Such changes and modifications are to be understood as being within the scope of the invention.

What is claimed is:

1. A resin molding apparatus comprising:
a fixed platen for supporting a fixed mold;
a movable platen for supporting a movable mold;
a tie bar for connecting the movable platen to the fixed platen; and
a bush bearing fixed to the movable platen at a position to be in contact with the tie bar, the movable platen being movable along the tie bar via the bush bearing,
wherein a low friction surface treatment is applied to at least one of a surface of the tie bar in contact with the bush bearing and a surface of the bush bearing in contact with the tie bar.

2. A resin molding apparatus according to claim 1, wherein:
the tie bar pierces through the bush bearing; and
the low friction surface treatment is applied to an outer circumference of the tie bar.

3. A resin molding apparatus according to claim 1, wherein:
the tie bar pierces through the bush bearing; and
the low friction surface treatment is applied to an inner circumference of the bush bearing.

4. A resin molding apparatus according to claim 1, wherein the low friction surface treatment is forming a hard lubricating layer.

5. A resin molding apparatus according to claim 4, wherein the hard lubricating layer is made of diamond-like carbon.

6. A resin molding apparatus according to claim 4, wherein the hard lubricating layer is made of diamond-like carbon containing an additive.

7. A resin molding apparatus according to claim 4, wherein the hard lubricating layer is made of CrN.
